(19) United States
(12) Patent Application Publication
(10) Pub. No.: US 2012/0025707 A1
(43) Pub. Date: Feb. 2, 2012

(54) LED LAMP

(75) Inventors: Xinshen Xue, Shenzhen (CN); Dezhi Zou, Shenzhen (CN); Huijuan Fang, Shenzhen (CN)

(73) Assignee: Civilight Shenzhen Semiconductor Lighting Co., Ltd, Shenzhen (CN)

(21) Appl. No.: 12/903,571

(22) Filed: Oct. 13, 2010

(30) Foreign Application Priority Data
Jul. 30, 2010 (CN) 201010241952.4

(51) Int. Cl. H01J 13/46

(52) U.S. Cl. 315/35

(57) ABSTRACT

The present invention relates to illuminating techniques, and provides an LED lamp includes a lamp body, an LED lath inside the lamp body, plug modules disposed at both ends of the lamp body, and driving powers electrically connected the LED lath with the plug modules. The lamp body includes a heat dissipating cover and a light-transmissive cover which are connected with each other. The LED lath includes a lath and a plurality of LEDs disposed along the length direction of lath. The end LEDs disposed at the both ends of the lath have light-emitting surfaces which are inclined and irradiated to the driving power. For the LED lamp provided in the present invention, each end LED disposed at the end of the lath has an inclined light-emitting surface. Accordingly, the light emitting from the end LEDs at the both ends could irradiate to the driving powers at the both ends, and thus avoiding the shadow of LED lamp, and improving the emitting effect.

### TECHNICAL FIELD

The present invention relates to illuminating techniques, and more particularly, to an LED lamp.

### BACKGROUND

As a new type of light source, LED lamps have advantages of small size, low energy consumption, strong applicability, high stability, short response time, environmental protection, multicolor emitting, etc., and are widely used in the fields of lighting and decoration. The lamps with a light source of high power LEDs have advantages of high efficiency of emitting, energy-saving, environmental protection, etc. On the other hand, traditional abandoned fluorescent lamps easily bring out mercury pollution, thereby, it's urgent to use LED lamps to replaces traditional fluorescent lamp. The traditional LED lamp mainly includes a lamp body, plugs respectively disposed at the both ends of the lamp body, an LED lath disposed inside the lamp body, driving powers electrically connected between lamp pins inside the plugs and the LED lath. The lamp body includes a heat dissipating cover and a light-transmissive cover. At present there are two methods of arrangement of the driving power in the existing technology. The first method is that the driving power is interposed between the heat dissipating cover and the LED lath. The second method is that the driving power is disposed at the both ends of the LED lath. The LED lamp using the first method has disadvantages of obvious light spots of LED and low safety coefficient. The LED lamp using the second method has disadvantages of shadow occurring at both ends of the LED lamp and low safety coefficient.

Furthermore, the LED lamp produces a quantity of heat when LED lamp is working. The traditional LED lamp usually has a problem of terrible heat dissipation. so there is safety trouble that a quantity of heat accumulation could burn the driving power or the LED lamp.

### SUMMARY

Therefore, according to an aspect of the present invention, an LED lamp is provided for improving of the traditional LED lamp, and avoiding the shadow of the LED lamp, and improving emitting effect.

An LED lamp includes a lamp body, an LED lath inside the lamp body, plug modules disposed at both ends of the lamp body, and driving powers electrically connected the LED lath with the plug modules. The lamp body includes a heat dissipating cover and a light-transmissive cover which are connected with each other. The LED lath includes a lath and a plurality of LEDs disposed along a length direction of the lath. The plurality of LEDs comprising end LEDs disposed at the both ends of the lath, each end LED having a light-emitting surface which is inclined and allows light to be irradiated to the driving power.

In the above LED lamp, the end LEDs disposed at the both ends of the lath have inclined light-emitting surfaces, accordingly, the light emitting from the end LEDs disposed at the both ends could irradiate to the driving powers at the both ends, thereby avoiding the shadow of the LED lamp resulting from the driving powers, and improving emitting effect.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic, front plan view of the LED lamp in accordance with an embodiment of the present invention;

FIG. 2 is a schematic, exploded view of the LED lamp in accordance with the embodiment of the present invention;

FIG. 3 is a perspective view of the LED lath in accordance with the embodiment of the present invention;

FIG. 4 is an enlarged view of section A of FIG. 2;

FIG. 5 is an enlarged view of section B of FIG. 2; and

FIG. 6 is a schematic, exploded view of the plug module in accordance with the embodiment of the present invention.

### DETAILED DESCRIPTION OF THE PREFERRED EMBODIMENTS

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

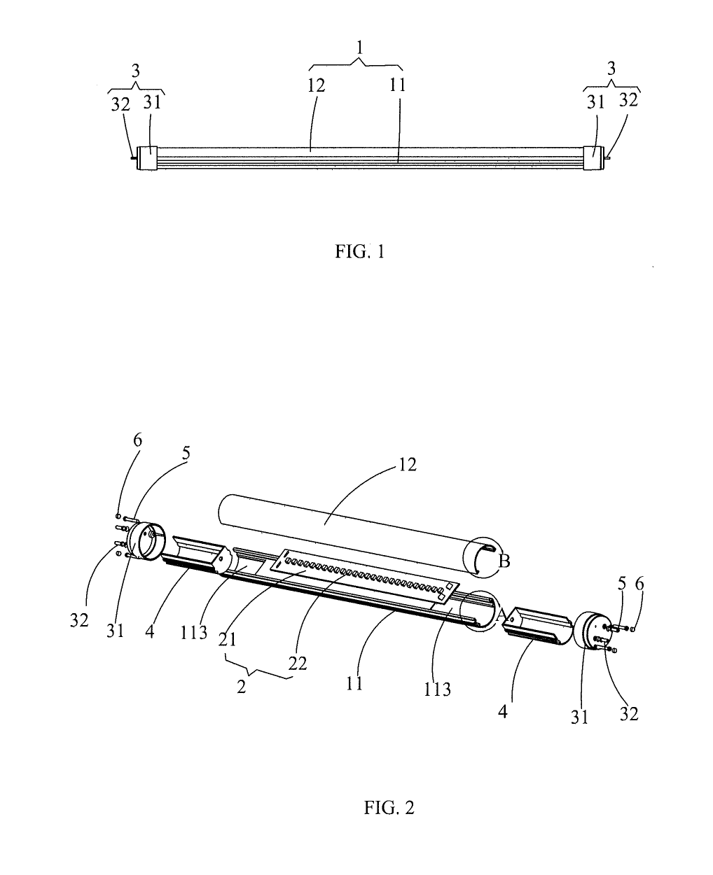

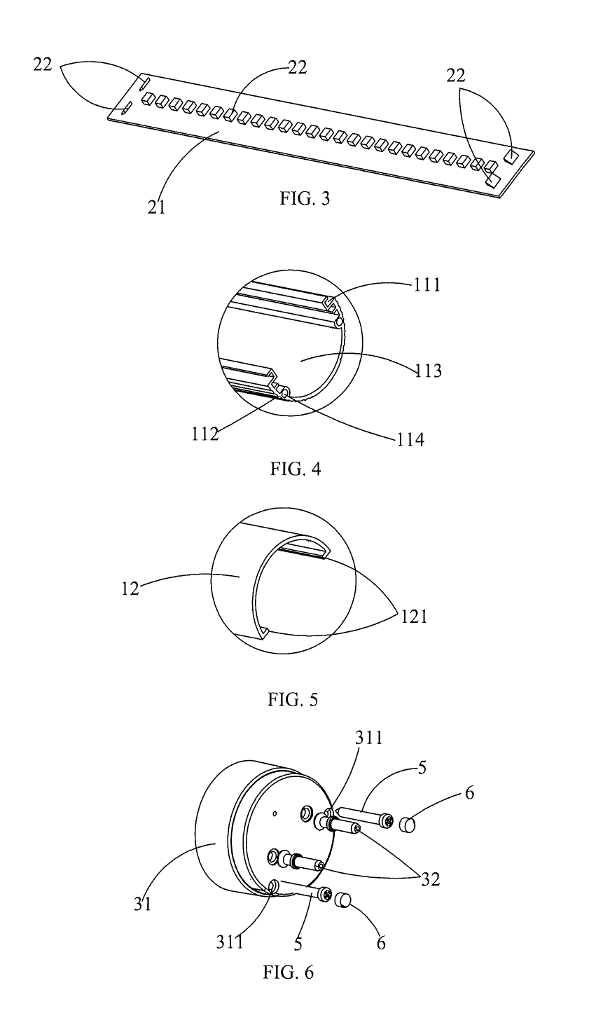

Referring to FIG. 1 and FIG. 2 which are the perspective views of the LED lamp. The LED lamp includes a lamp body 1, an LED lath 2 disposed inside the lamp body 1, plug modules 3 disposed at both ends of the lamp body 1 and driving powers (not shown) electrically connected the LED lath 2 with the plug modules 3. The lamp body 1 includes a heat dissipating cover 11 and a light-transmissive cover 12. The two covers 11, 12 are connected with each other. The LED lath 2 includes a lath 21 and a plurality of LEDs 22 disposed along a length direction of the lath 21. The plurality of LEDs 22 includes end LEDs 22 disposed at the both ends of the lath 21 and each end LED 22 has a light-emitting surface which is inclined and allows light to be irradiated to the driving power.

For the LED lamp according to an embodiment of the present invention, these LEDs 22 disposed at the both ends of the lath 21 each have inclined a light-emitting surfaces. The light emitting from LEDs 22 at the both ends could be irradiated to the driving powers at the both ends, thereby avoiding the shadow of LED lamp, and improving the emitting effect.

Referring to FIG. 1 and FIG. 2, the lath 21 is attached on the inside of the heat dissipating cover 11 by silicone film. The silicone film with thermal conductivity between 4-5 is provided with double functions of heat conductive and insulative. Through attaching the lath 21 on the heat dissipating cover 11, heat generated from the LEDs 22 disposed along the length direction of lath 2 can be uniformly and quickly transferred to the heat dissipating cover 11. This effectively protects the LEDs 22 and the lath 1, and prolongs working life thereof.

In this embodiment, the driving powers (not shown) are respectively disposed at the both ends of the lamp body 1, and connected with the LED lath 2 and the plug module 3. Because the driving powers are respectively disposed at the both ends of the lamp body 1, in the traditional LED lamp, the mounted LED lamps can't irradiate to the driving powers, accordingly, shadows is formed at position of the driving powers which in turn produces influence on effect of irradiation. In the embodiment, the end LEDs 22 disposed at the both ends of the lath 21 each are in a rhombic shape, and are decliningly welded on the lath 21. Meantime, in order to improve illumination, each end of the lath 21 is provided with two rhombic end LEDs 22 disposed thereon. The two rhombic end LEDs 22 at each end are radially arranged on the lath 21, and enlarges the scope of the irradiation thereof In this declining way, the light-emitting surfaces of the rhombic end LEDs 22 are oriented to directly irradiate to the driving powers which are disposed at the both ends of the lamp body 1. Accordingly, when the entire lath 2 emitting, others LEDs 22 on the lath 2 except of the end LEDs axially irradiate the lamp body 1, and the both ends of the light-transmissive cover 12 are illuminated. Meanwhile, the light emitted by the rhombic end LEDs 22 disposed at the both ends of the laths is directly irradiated towards the driving powers. A part of the light from the end LEDs 22 illuminates the driving powers and would not produce shadows, while another part of the light emitted by the rhombic end LEDs 22 is reflected to the light-transmissive cover 12 by the driving powers. The reflected light further strengthens the illuminating intensity of the both ends of light-transmissive cover 12. This improves the effect of illumination of LED lamp, and would not produce shadows at both ends.

Since the light-emitting surfaces of the rhombic end LEDs 22 have structure of curved surface, when curved light-emitting surfaces satisfy enough irradiation, the rhombic end LEDs 22 may be directly welded on the lath 21 other than to be bonded via inclining weld.

Furthermore, the end LEDs 22 disposed at the both ends of the lath 21 also could be in other shapes, such as rectangle. The rectangular end LEDs 22 are decliningly welded on the lath 21. The declining angle is defined by factors such as the shape of the driving power. Therefore, the rectangular end LEDs 22 decliningly positioned are provided with light-emitting surfaces that could directly irradiate to the driving power, thereby avoiding the shadow produced by sheltering of the driving power, and improving the emitting effect of the LED lamp.

In this embodiment, in order to be easy to disassemble and fix the lamp body 1, the heat dissipating cover 11 and the light-transmissive cover 12 use buckle structure. Referring to the FIG. 4, cross section of the heat dissipating cover 11 is in a shape of “C”, flanges with axial buckle grooves 111 are axially provided at both sides of the outside of the peristome of the “C” shape of the heat dissipating cover 11. Please referring to FIG. 5, cross section of the light-transmissive cover 12 also is in a shape of “C”, rib strips 121 that could engage into the buckle grooves 111 extend inwardly and defined at the both sides of the inside of the peristome of the “C” shape of the light-transmissive cover 12. The connecting structure of the heat dissipating cover 11 and the light-transmissive cover 12 is not only limited to above structure, but also could be replaced by other fixing structures that are easy to disassemble and reliably connect.

Specificially, referring to FIG. 4, in the embodiment, finny heat dissipating ribs 112 are axially and parallelly disposed on an exterior of the heat dissipating cover 11 in uniform interval. Two concaved recessiones 113 are defined in both ends of the heat dissipating cover 11. Threaded holes are defined in the axial end surface of the heat dissipating cover 11. In the embodiment, the heat dissipating cover 11 is made from ceramic material with good thermal conductivity, or alternatively other materials with good thermal conductivity, such as Aluminium.

Specificially, the light-transmissive cover 12 is made of PC (Polycarbonate) light diffusing material, which improves the light diffusion and provides the lamp with uniform light effect, and better luminous effect, because the LED pots can't be seen from outside of the lamp body 1.

Furthermore, in order to satisfy the related safety regulation of the LED lamp, avoid of being fired by accumulating quantity of heat when the driving power is working, and improve safety thereof. In this embodiment, the driving power is disposed inside a thermal conductive and insulated shell 4. The thermal conductive and insulated shell 4 is disposed in the recession 113 defined at the both ends of the heat dissipating cover 11. Therefore, the quantity of heat in the driving power quickly conduct to the heat dissipating cover 11 by the thermal conductive and insulated shell 4 through which dissipates the quantity of the heat to the air. Furthermore, in this embodiment, in order to strengthen conductive effect of heat, a thermal conductive silica gel (not shown in the figure) is fixed inside the thermal conductive and insulated shell 4. Meanwhile, high pressure test on the anyplace of outside of the lamp body 1 should be passed while using the thermal conductive and insulated shell 4. Thus, the lamp is safe and reliable.

Specificially, referring to FIG. 2 and FIG. 6, the plug module 3 includes a plug 31 and pins 32 that extend though the plug 31 and electrically connected with the driving power. The plug 31 is formed with threaded holes 311 corresponding to the threaded holes 114 through the heat dissipating cover 11. The plug 31 is connected with the heat dissipating cover 11 by screws 5 which rotate between threaded holes 311 and corresponding threaded holes 114. Meanwhile, in order to keep feeling of integration, a protective shell 6 covering the screws 5 is disposed outside of the threaded holes 311 in the plug 31. Therefore, the protective shell 6 and plug 31 is configured as a whole, which provides better aesthetic effect for the lamp.

In summary, in the above embodiment of the present invention, the end LED has declining light-emitting surface that could directly irradiate to the two ends of the lamp body 1, through declining LEDs or LEDs with curved planes which both are disposed at the both ends of the lamp 21. This avoids the shadow produced by shelter of the two end of the driving power, and improves the illuminative efficiency of LED lamp. In addition, the thermal conductive and insulated shell 4 disposed outside of the driving power accelerates the dissipating efficiency, and high pressure test could be passed on the anyplace of outside of the lamp body 1, thereby improving safety and reliability thereof.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. An LED lamp comprising:
a lamp body, the lamp body comprising a heat dissipating cover and a light-transmissive cover which are connected with each other;
an LED lath disposed inside the lamp body, the LED lath comprising a lath and a plurality of LEDs disposed along a length direction of lath;
plug modules disposed at both ends of the lamp body; and
driving powers electrically connected the LED lath with the plug modules;
the plurality of LEDs comprising end LEDs disposed at the both ends of the lath, each end LED having a light-emitting surface which is inclined and allows light to be irradiated to the driving power.

2. The LED lamp as claimed in claim 1, wherein each end LED disposed at the end of the lath is in a rhombic shape, and is decliningly or vertically welded on the lath.

3. The LED lamp as claimed in claim 1, wherein each LED disposed at the end of the lath is in a rectangle shape, and is decliningly welded on the lath.

4. The LED lamp as claimed in claim 1, further comprising a thermal conductive and insulated shell at each end of the lamp body, each driving power being disposed inside one respective thermal conductive and insulated shell, two ends of the heat dissipating cover each having a recession for arranging the thermal conductive and insulated shell therein.

5. The LED lamp as claimed in claim 4, wherein a thermal conductive silica gel is fixed inside the thermal conductive and insulated shell.

6. The LED lamp as claimed in claim 4, wherein each plug module comprises a plug and a plurality of pins that extend through the plug and electrically connected with the driving power, the plug and the axial end surface of the heat dissipating cover correspondingly defining threaded holes therethrough, the plug being connected with the heat dissipating cover by screws rotating into the threaded holes in the heat dissipating cover and the plug, a protective shell being covered on the outside of the threaded holes on the plug.
